(19) United States
(12) Patent Application Publication
(10) Pub. No.: US 2009/0133282 A1
(43) Pub. Date: May 28, 2009

(54) Method and Apparatus for Drying a Moving Web of Material at a Paper or Board Machine

(75) Inventors: Jari Rasanen, Imatra (FI); Seppo Karine, Imatra (FI)

Correspondence Address: BIRCH STEWART KOLASCH & BIRCH, PO BOX 747, FALLS CHURCH, VA, 22040-0747, US

(73) Assignee: Stora Enso Oyj, Helsinki (FI)

(21) Appl. No.: 11/988,553

(22) PCT Filed: Jul. 20, 2006
(86) PCT No.: PCT/FI2006/000262

§ 371 Date: Feb. 25, 2008

(30) Foreign Application Priority Data
Jul. 20, 2005 (FI) 20050774

(51) Int. Cl. F26B 3/00; F26B 11/02

(52) U.S. Cl. 34/461; 34/117

(57) ABSTRACT

The invention relates to a method and an apparatus for drying a moving web of material at a paper or board machine. The drying is performed by a heated drying cylinder (1) transverse to the direction of travel of the web, past which the web is being led. According to the invention, the drying cylinder (1) has been constructed so that its temperature can be adjusted independently at different locations in the longitudinal direction of the cylinder, i.e. the transverse direction of the web. With the adjustability of the drying cylinder it is possible to eliminate moisture differences occurring in the transverse direction of the web in connection with the drying. Especially, it is possible to eliminate moisture lines in the longitudinal direction of the web, which are generated when forming the web on the wire. The drying can be done by independently adjustable resistance wires (12) arranged at different locations of the cylinder, by heating vapour supplied independently to different zones of the cylinder, or by using both drying methods simultaneously in the same drying cylinder.

The invention relates to a method for drying a moving web of material at a paper or board machine, in which the web is dried with a heated drying cylinder transverse to the direction of travel of the web, past which the web is being led. In addition, the invention relates to an apparatus, with which the method can be applied.

In a conventional paper or board manufacturing process, stock is continuously fed to an endless wire for forming a web of fibre material. The generated continuous web is transferred from the wire to the compression section of the paper or board machine, and further to the drying section of the machine, in which the web is typically dried by several heated drying cylinders successive in the direction of travel of the web. At the machine, the drying can be followed by the gluing of the web, the drying of the glue, the calendering of the web for tightening or polishing its surface and, finally, the rolling of the finished web to a roll core as a so-called machine roll.

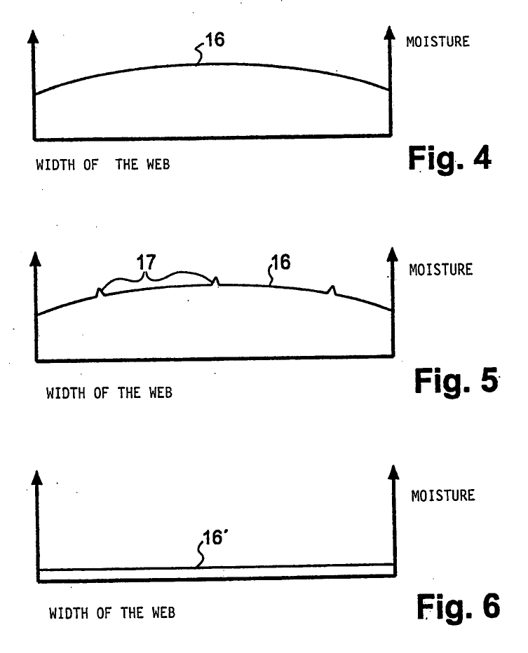

When drying the web at a paper or board machine, the situation is most often such that the moisture of the web arriving at the drying section of the machine or travelling through its successive drying cylinders in the drying section is not uniform, but there are variations in the transverse direction of the web. Thus it is typical that due to the air flows generated by the movement of the web, the web will dry more at its edges than in the middle area between them. In this case, the transverse moisture profile of the web is convex, which has been illustrated in FIG. 4 of the patent drawings to be explained in more detail later. Another phenomenon shown as irregularities in the moisture profile of the web are the longitudinal moisture lines of the web, i.e. rather narrow longitudinal zones, in which the moisture of the web is clearly higher than in the areas immediately on both sides of the zone in question. The moisture lines typically originate from the wire section of the machines, in which the web was formed, resulting thus, for example, from local disturbances caused by blockages in the removal of water in the transverse direction of the wire. The moisture lines are shown as upwards extending peaks in the transverse moisture profile of the web according to FIG. 5 of the claims.

When uniform heating is applied to the web from the drying cylinders in the drying section of current paper or board machines, the irregularities in the moisture profile will remain even if the moisture of the web in all will considerably decrease in the drying. Up till now it has been tried to balance the moisture of the web after the drying step either by additional drying, such as IR radiation applied to the areas of the dried web that have remained wetter, or by moistening the areas of the web that have dried the most. However, such balancing measures provide the manufacturing process of the web with extra steps that are difficult to control, and the new moistening of the web additionally means that energy will be wasted, taking the whole drying process into consideration.

The object of the present invention is to solve the said problem caused by the irregular moisture profile of the web, especially by the longitudinal moisture lines of the web in a simpler and, for the use of energy, in a more inexpensive manner. In the invention, the balancing of the moisture profile of the web, i.e. the moisture differences in the transverse direction of the web is arranged to occur when drying the web in the drying section of the paper or board machine, the solution consisting essentially of independently adjusting the temperature of the drying cylinder at different locations in its longitudinal direction for balancing, in connection with the drying, the moisture differences in the transverse direction of the web which are due to moisture lines in the longitudinal direction of the web that are generated upon forming the web on the wire.

Thus, the invention offers an option to tailor the heating effect applied to the web from the drying cylinder according to the moisture profile in question of the web, i.e. to apply a stronger heating to the locations of the web that are distinguished in the moisture profile is wetter than others and, respectively, a milder heating to those places that are drier than the others. The result is a straightening of the moisture profile of the web in connection with the drying process; in an ideal case, changing the profile to be linear so that there will be no moisture differences in the transverse direction of the web that is fully dried.

The basic objective of the invention is to adjust the temperature of the drying cylinder so that it is possible with the adjustment to eliminate longitudinal moisture lines of the paper or board web that are generated in the wire section of the machine when forming the web. The technical solution suitable for this purpose is to place resistance wires at suitable relatively dense intervals to different locations in the longitudinal direction of the drying cylinder and to adjust the electric current travelling in each resistance wire independently, irrespective of the other wires. By means of this solution, the heating of the cylinder and the drying effect caused by this can be intensified at the locations in the longitudinal direction of the cylinder, i.e. the transverse direction of the web, in which the moisture lines are located.

The balancing of the moisture lines typically includes that the temperature of the cylinder is adjusted higher at two or more locations in the longitudinal direction of the drying cylinder than at locations immediately on both sides of the first-mentioned locations for balancing the moisture differences due to two or more moisture lines in the longitudinal direction of the web.

When adjusting the drying of the web in accordance with the invention, the heating efficiency of the drying cylinder in the middle area of the cylinder can be generally arranged to be higher than at its opposite ends, in which case the cylinder will balance the moisture differences of the web that is wetter in the middle and drier at its edges. The general problem caused by air flows and appearing as convexity of the moisture profile of the web can thus be solved. A practical solution can be, for example, to divide the interior of the drying cylinder into successive zones in the longitudinal direction of the cylinder so that heating vapour can be fed to different zones independently. Thus, the hottest vapour can be fed to the middlemost zone of the cylinder drying the middle section of the web, and the zones symmetrically on both sides of it can be supplied gradually with vapour with a lower temperature so that the heating vapour with the lowest temperature always effects at the opposite edges of the web.

One advantageous embodiment option of the invention is to combine the said two ways of heating in the same drying cylinder. Thus, the vapour heated into different temperatures and led to the different zones in the cylinder can take care of the general balancing of the convex moisture profile of the web, at the same time as the longitudinal moisture lines distinguishing as peaks from the convex moisture profile can be separately eliminated by resistance wires placed in the casing of the cylinder.

According to the invention, the apparatus of the invention for drying a moving web of material at a paper or board machine, which apparatus comprises at least one heated drying cylinder transverse to the direction of travel of the web that is arranged to travel past the drying cylinder, is especially characterised in that resistance wires extensing annularly around the cylinder have been arranged at different locations in the longitudinal direction of the drying cylinder, the electric current being independently adjustable in each of the wires so that the temperature of the drying cylinder can be adjusted independently at different locations in its longitudinal direction for balancing in connection with the drying moisture differences occurring in the transverse direction of the web, the differences due to moisture lines in the longitudinal direction of the web.

The invention will next be explained in more detail by means of examples, referring to the enclosed drawings, in which

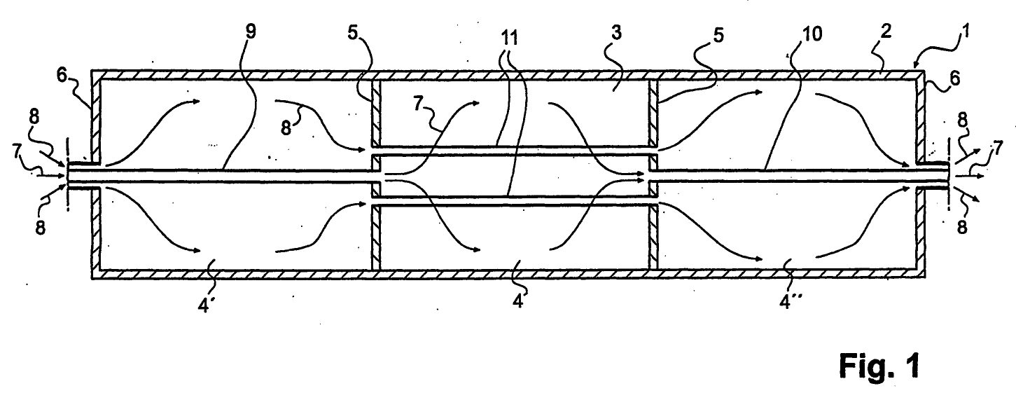

FIG. 1 is a longitudinal section of a drying cylinder operated by heating vapour and applicable to the drying of a paper web;

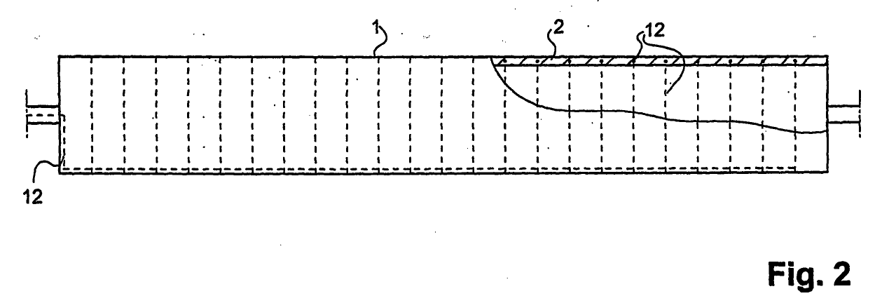

FIG. 2 shows a partly cut view of a drying cylinder of the invention operated by electrical resistors and applicable to the drying of a paper web;

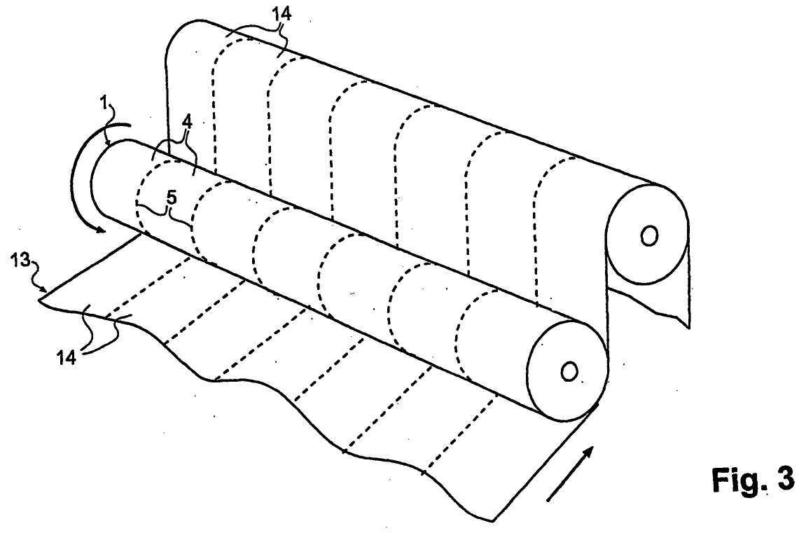

FIG. 3 presents the drying of a paper web with the drying cylinders in the drying section of a paper machine;

FIG. 4 presents the moisture profile of the paper web to be dried in the transverse direction of the web, the web being wetter in the middle section than at its edges;

FIG. 5 is a moisture profile of a web similar to FIG. 4, including also moisture lines in the longitudinal direction of the web; and

FIG. 6 presents the ideal moisture profile of the web after the drying step.

FIG. 1 is a principle drawing of a drying cylinder 1, which is part of the drying section of a paper machine, the purpose of the drying cylinder being the drying of the paper web that has been formed in the wire section of the machine and that has traveled through the compression section of the machine. The drying cylinder 1 comprises a longitudinal cylindrical casing 2, partitions 5 that divide the interior 3 of the cylinder into successive departments or zones 4, 4′, 4″ in its longitudinal direction, and end walls 6 closing the ends of the cylinder. In the embodiment shown, which is as simple as possible, the cylinder has been divided into three successive zones, namely the middle zone 4 and the edge zones 4′, 4″ located symmetrically on both sides of it but, in practice, the number of partitions 5 and the zones 4 separated by them may be considerably larger.

The heating of the drying cylinder 1 for achieving a drying effect applied to the paper web travelling past the cylinder is performed by heating vapour led through the interior 3 of the cylinder. In the illustrated embodiment, two separate vapour flows 7, 8 penetrate the cylinder 1 so that the one vapour flow 7 with a higher temperature is used for heating the middle zone 4 of the cylinder and the second vapour flow 8 with a lower temperature is used for heating the edge zones 4′, 4″ on both sides of the middle zone. The hotter vapour flow 7 has thus been led axially from the end of the cylinder through the channel 9 penetrating the first edge zone 4′ to the middle zone 4 of the cylinder to heat the cylinder casing 2 in this section of the zone, and further axially out from the opposite end of the cylinder through a channel 10 penetrating the second edge zone 4″ of the cylinder. The vapour flow 8 with the lower temperature has again been led from the end of the cylinder to its first edge zone 4′ to heat the cylinder casing 2 in the section of this zone and further, through channels 11 penetrating the middle zone 4 of the cylinder to the second edge zone 4″ to respectively heat the cylinder casing also in this section of the zone, and finally out from the opposite end of the cylinder.

If the interior 3 of the cylinder has been divided into several successive zones 4 by the partitions 5, several heating vapour flows, which are progressively at different temperatures, can be respectively led through the cylinder. The general principle is to heat the cylinder casing 2 most strongly in its middle section and progressively less towards the opposite ends 6 of the cylinder. It is also possible to make the possible vapour flows to flow through the cylinder to opposite directions in relation to each other.

In the embodiment illustrated in FIG. 2, the heating of the casing 2 of the drying cylinder 1 is arranged to occur with independently adjustable resistance wires 12 that extend around the casing and are distributed over the length of the casing at equal intervals. The distance of the wires can be 1-30 cm, preferable 2-20 cm, and most preferably 3-15 cm. By adjusting the electrical current travelling in the wires 12, it is thus possible to bring the casing 2 to different temperatures at different locations, corresponding to the drying need at different locations of the paper web that is led past the cylinder 1. Especially well the illustrated solution is suited for the elimination, according to the invention, of moisture lines in the longitudinal direction of the web, i.e. at places that are wetter than the environment. The electric current travelling in the resistance wire or wires by the moisture line will be increased in relation to the adjacent wires at the same time as the general need of drying the web can be attended to by other adjusting of the wires, for example so that a stronger heating is generally applied to the middle section of the web than to the edges.

It is also possible to combine the methods for drying the cylinder casing 2 illustrated in FIGS. 1 and 2 in a one and same drying cylinder 1. In this case, vapour flows penetrating the cylinder can be used for heating the middle section of the casing hotter than the edge zones at the same time as the precise adjustment of the heating for making the casing at certain locations hotter than in the surroundings, especially for eliminating the longitudinal moisture lines of the web, can be achieved by the resistance wires in the casing.

FIG. 3 is a principle drawing of the drying of a wet paper web 13 with the drying cylinder 1 in the drying section of a paper machine. In the Figure, there are two successive cylinders 1 in the direction of travel 13 of the web, past which the web is arranged to travel; but, iri practice, the number of cylinders in the machine is in general considerably larger. The structure and operation mode of the drying cylinders 1 are principally similar to those in FIG. 1, but the cylinders have been divided into seven successive zones 4 by the partitions 5 illustrated by broken line, the heating vapour flows being led through the cylinder via the said zones. There are advantageously four separate vapour flows arranged so that the hottest flow heats the middle section of the cylinder, and the progressively cooler flows heat the zones that surrounds the middle section symmetrically in pairs. With this arrangement it is achieved that the casing of the cylinder is the hottest in the middle of the cylinder, cooling gradually down towards the opposite ends of the cylinder. The resistance wires achieving the fine adjustment of the drying have been omitted from FIG. 3.

The longitudinal zones 14 of the paper web 13 to be dried, corresponding to the successive zones 4 of the cylinder separated by the partitions 5 have been shown with broken lines 15 in FIG. 3. The drying effect achieved by separate vapour flows is most strongly applied to the middlemost longitudinal zone of the web 13, abating towards the edges of the web. However, the convection of heat in the casing of the cylinder balances the drying effect so that the drying of the web does not occur progressively in accordance with the zones, but the drying effect weakens by gliding more or less from the centre of the web towards its edges.

FIG. 4 illustrates a typical transverse moisture profile 16 of the web to be dried, i.e. moisture in the direction of width of the web at the beginning of the drying. It can be seen that the web is wetter at its centre than at its opposite edges. In the moisture profile according to FIG. 5 there can additionally be seen longitudinal moisture lines, which are distinguished as upwards directing peaks 17 in the profile. In addition to the general decrease in the moisture of the web, also the smoothing of the moisture profile 16, i.e. the general straightening of the profile and the elimination of the moisture lines appearing as peaks 17 can be achieved by drying the web according to the invention. In an ideal case, after the drying the profile 16′ will be horizontal according to FIG. 6, i.e. the moisture content of the finished dried web is constant.

It is obvious for one skilled in the art that the embodiments of the invention are not restricted to the one illustrated as the example, but they can vary in scope of the following claims.

1. A method for drying a moving web of material (13) at a paper or board machine, in which the web is dried with a heated drying cylinder (1) transverse to the direction of travel of the web, past which the web is being led, characterised in that the temperature of the drying cylinder (1) is adjusted independently at different locations in its longitudinal direction for balancing moisture differences in connection with the drying, the differences occurring in the transverse direction of the web (13) and being due to moisture lines (17) in the longitudinal direction of the web that are generated upon forming the web on the wire.

2. Method according to claim 1, characterised in that at two or more locations in the longitudinal direction of the drying cylinder (1), the temperature of the cylinder is adjusted higher than at locations of the cylinder immediately on both sides of the first-mentioned locations for balancing the moisture differences due to two or more longitudinal moisture lines (17) of the web (13).

3. Method according to claim 1 or 2, characterised in that the heating power of the drying cylinder (1) is arranged higher in the middle section (4) of the cylinder than at its opposite ends (4′, 4″) so that the cylinder will balance the moisture differences of a web (13), which is wetter in the middle and drier at its edges.

4. Method according to one of the preceding claims, characterised in that resistance wires (12) have been arranged at different locations in the longitudinal direction of the drying cylinder (1), and the electric current travelling in each wire is adjusted independently.

5. Method according to claim 4, characterised in that the interior (3) of the drying cylinder (1) has additionally been divided into successive zones (4, 4′, 4″) in the longitudinal direction of the cylinder, and that heating vapour (7, 8) is fed to the different zones independently so that the feeding of vapour balances the moisture differences in a web (13) which is wetter in the middle and drier at its edges.

6. An apparatus for drying a moving web of material (13) at a paper or board machine, comprising at least one heated drying cylinder (1) transverse to the direction of travel of the web, past which the web is arranged to travel, characterised in that resistance wires (12) extending annularly around the cylinder have been arranged at different locations in the longitudinal direction of the drying cylinder (1) the electric current being adjustable independently in each of the wires, so that the temperature of the drying cylinder can be adjusted independently at different points in its longitudinal direction for balancing in connection with the drying moisture differences occurring in the transverse direction of the web (13), the differences being due to moisture lines (17) in the longitudinal direction of the web.

7. Apparatus according to claim 6, characterised in that the annular resistance wires (12) are located at intervals of 1-30 cm, preferably of 2-20 cm, and most preferably of 3-15 cm in the longitudinal direction of the drying cylinder (1).

8. Apparatus according to claim 6 or 7, characterised in that the heating power of the drying cylinder (1) can be arranged to be higher in the middle section (4) of the cylinder than at its opposite ends (4′, 4″) so that the cylinder balances the moisture differences in a web (13) which is wetter in the middle and drier at its edges.

9. Apparatus according to claim 8, characterised in that the interior (3) of the drying cylinder (1) has been divided into successive zones (4, 4′, 4″) in the longitudinal direction of the cylinder and that heating vapour (7, 8) can be supplied independently to the different zones.
